(19) United States
(12) Patent Application Publication
(10) Pub. No.: US 2007/0079677 A1
(43) Pub. Date: Apr. 12, 2007

(54) Cutting method for DWDM filter

(75) Inventor: Chen-Yi-Sheng Zhang, Taichung (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Asia Optical Co., Inc.

(21) Appl. No.: 11/369,708

(22) Filed: Mar. 7, 2006

(30) Foreign Application Priority Data
Oct. 6, 2005 (TW) 094134969

(51) Int. Cl. B23Q 15/00

(52) U.S. Cl. 83/73

(57) ABSTRACT

A cutting method for DWDM filters includes a two-phase cutting process comprised of three steps. Step one is to form a slot in a substrate according to the size requirement of a finished product. The slot has a width larger than the thickness of a cutter that is used to perform cutting. Step 2 is to form coatings on the substrate and step 3 is to completely cut off a filter from the substrate at a center point of the slot. The two-phase cutting process avoids corner breaking caused by direct contact between the cutter and the coating layers of the filter.

### BACKGROUND OF THE INVENTION

1. Field of the Invention

The present invention relates generally to a cutting method for an optical filter, and more particularly to a cutting method for a dense wavelength division multiplexing (DWDM) filter, which comprises a two-phase cutting process.

2. Description of the Prior Art

With the development of broadband telecommunication service, the demand for the transmittance volume of the backbone network is increasing, and hence the technology of dense wavelength division multiplexing (DWDM), which can provide huge volume and diversity broadband service, is prospering accordingly.

The DWDM technology refers to a multiplexer which divides a wavelength or a group of wavelengths into a plurality of sub-wavelengths that have a relatively much higher density, thereby enabling an optical fiber to transmit a plurality of signals instead of only a single signal. Therefore, the efficiency of employing an optical fiber is greatly increased with the same cost of the ground construction thereof. Nowadays, there are mainly three methods for realizing DWDM, which respectively are Thin Film Filter (TFF), Array Wave Guide (AWG), and Fiber Bragg Gratting (FBC), among which TFF is more commonly applied.

TFF normally adopts a method of coating a thin film, which usually employs vapor deposition to alternately coat layers with different refractivity onto a surface of a flat and thin glass plate. The glass plate is then cut into flakes according to different size requirements for final products of the filters. When a light beam passes a filter so made, different wavelengths are separated from each other and thus achieving division of wavelength. However, if a coated filter plate, after a vacuum coating process, goes on to an accessional vapor deposition process using an ion gun, a great inner stress is induced therein. The inner stress often causes corners of a thin film filter, which is designated with reference numeral 90 in FIG. 1 of the attached drawings, to break off when the filter 90 is subject to cutting.

Referring to FIG. 2 of the attached drawings, the filter 90 is attached to an end face of a Grin lens 91 by glue or adhesive 92, which is usually heat curable, applied therebetween. The glue 92, before cured, is in a liquid form, which may flow beyond the whole contact area between the Grin lens 91 and the filter 90 and often fills in spaces formed by broken corners of the filter 90. Once being heated over for example 80° C. for curing, due to thermal expansion, the glue 92 filled in the broken corners will cause the filter 90 to slightly tilt or to space from the Grin lens 91, which results in poor contact interface between the filter 90 and the Grin lens 91 and thus deteriorating the quality of assembly.

### BRIEF SUMMARY OF THE INVENTION

An object of the present invention is to provide a cutting method for a dense wavelength division multiplexing (DWDM) filter, which aims to solve the above-mentioned problem caused by corner breaking.

In order to achieve the above object and overcome the above-identified deficiencies in the prior art, the cutting method in accordance with the present invention comprises three steps. The first step is to form a slot, whose width is double the thickness of a cutter used to form the slot, in a substrate in accordance with size requirements of the finished products. The second step is to form coatings on the substrate. The third step is to completely cut through the substrate at a center point of the slot to separate the slotted flake off the substrate.

Compared with the prior arts, the cutting method in accordance with the present invention comprises two-phase cutting process, which effectively eliminating the potential corner breaking caused by direct contact between a cutter and coating layers of the substrate. Thus, quality of the final product of the optical filter can be ensured. Moreover, the cutting method of the present invention also has the advantage of easy operation.

Other objects, advantages, and novel features of the invention will become more apparent from the following detailed description of the best mode for carrying out the present invention, with reference to the accompanying drawings.

### BRIEF DESCRIPTION OF THE DRAWINGS

The present invention may best be understood through the following description with reference to the accompanying drawings, in which:

FIG. 1 is a schematic view showing an optical filter made by a conventional cutting method;

FIG. 2 is a schematic view showing the filter of FIG. 1 mounted to a Grin lens;

FIGS. 3a and 3b are schematic views showing a substrate processed in steps one and two respectively in accordance with the present invention;

FIG. 4 is a schematic view illustrating the status of step 2 of the cutting method in accordance with the present invention;

FIG. 5 is a schematic view observed from the side of an optical filter produced by the cutting method in accordance with the present invention;

FIG. 6 is a schematic view observed from the bottom of the optical filter of FIG. 5; and

FIG. 7 is a schematic view of the assembly of the optical filter of FIG. 5 and a Grin lens.

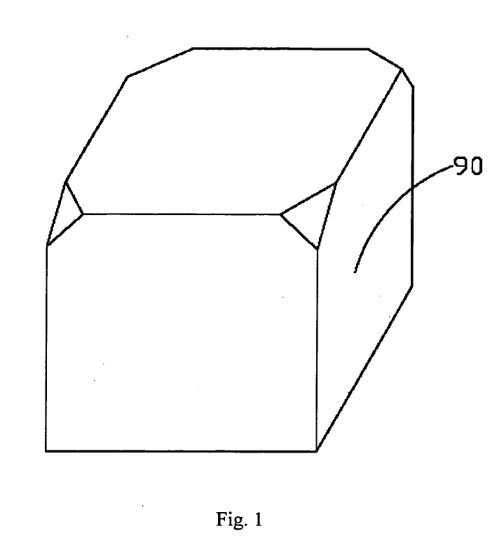

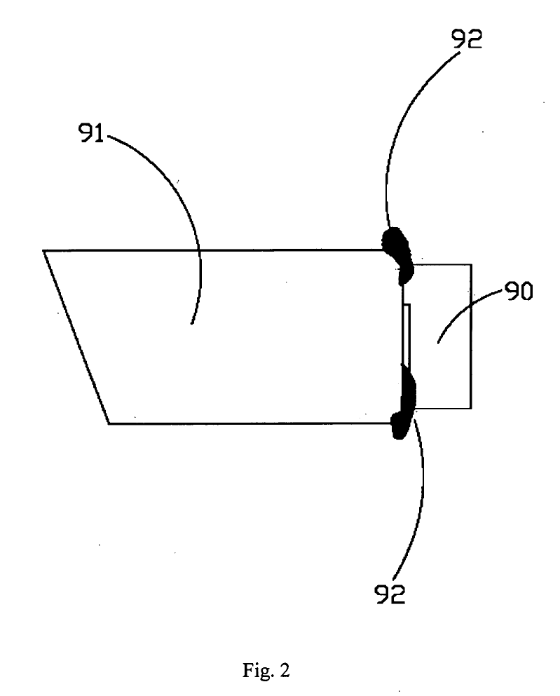

### DETAILED DESCRIPTION OF THE BEST MODE FOR CARRYING OUT THE INVENTION

The present invention provides a cutting method for cutting an optic device, such as a thin film filter, in a two-phase process comprising three steps, among which, the first step (phase one) is to form, with the aid of a cutter having a given thickness, slots in a substrate that forms the optic device in accordance with the dimensions of a final product of the optic device, the slots having a width substantially double or more times of the cutter thickness; the second step is forming coating on the substrate, in which the slots have already been formed; and the third step is to directly cut the slotted flake off the substrate from along a center line of each slot.

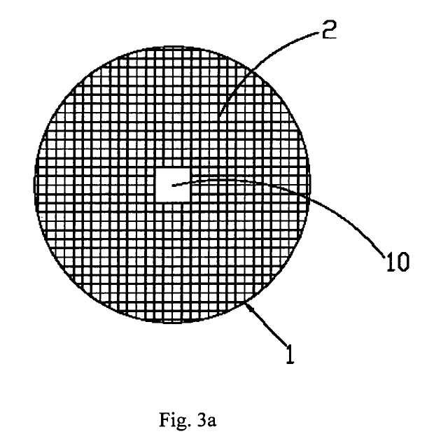

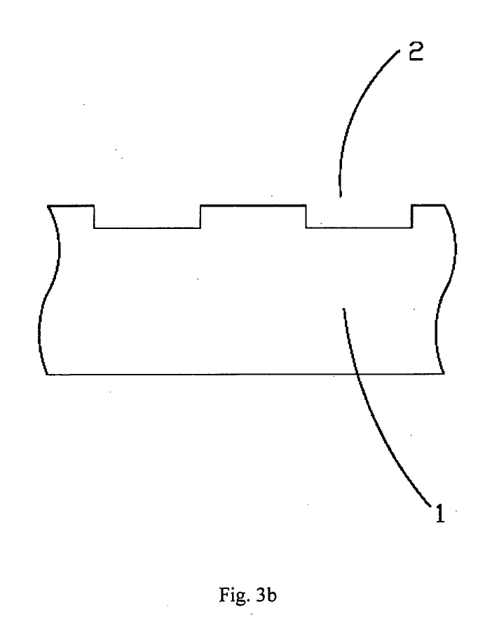

Referring to FIGS. 3a, 3b, 4, and 5, in a preferred embodiment of the present invention, the substrate, which is designated with reference numeral 1, is a flat and thin circular glass plate. Firstly, in the first step of the present invention, a square area is made at the center of the substrate 1 to serve as a monitoring area 10 for coating process thereof. With the aid of a cutter having a given thickness that is not shown in the drawings, slots 2 are then formed by cutting along directions of row and column set on the substrate 1 (see FIG. 3a), which delimit a plurality of chips that is sized according to the size requirements of finished products. The width of the slots 2 is equal to or more than double the thickness of the cutter. The cutting operation of the slot 2 may be made by repeatedly feeding the cutter in and out of the substrate 1, namely by repeating to cut a plurality of slim slots side by side on the surface of the substrate 1 to form the final slot 2. In other words, the slot 2 is composed of a plurality of slim slots that are arranged closely side by side with edges thereof overlapping or connecting each other.

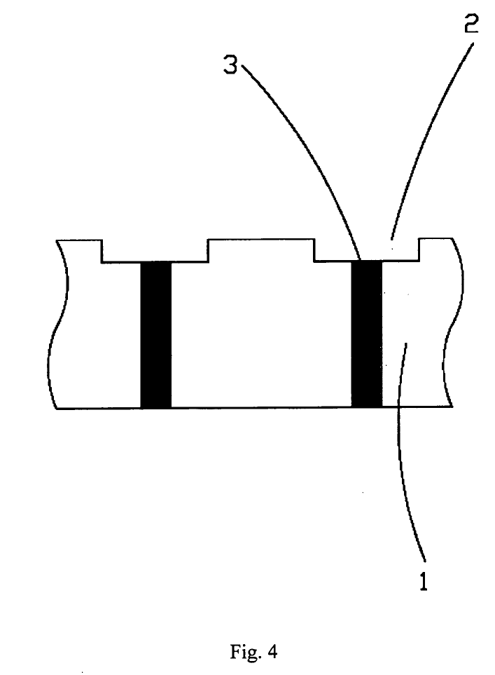

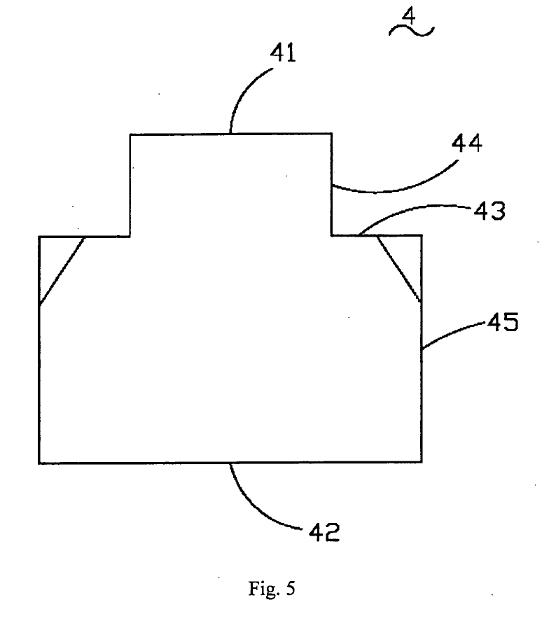

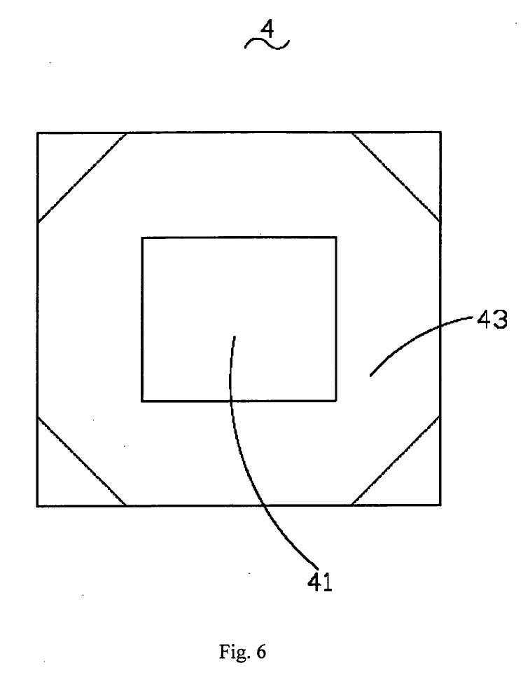

In the second step, a plurality of coating layers having high and low refractivity are alternatively coated on the surface of the substrate, making the layers overlapping each other. During this step, the coating of the layers on the substrate 1 may induce a great inner stress in the layers, which stress may cause corners thereof to break off during a cutting operation. The monitoring area 10 is provided for monitoring purposes. After the coating step is finished, the cutter is moved to a center point 3 of the slot 2 and is made to cut through the thickness of the substrate 1 below the slot 2, as indicated by black portion of FIG. 4, which completes the third step. The cutter is fed to cut completely through the remaining part of the substrate 1 to separate the optical filter 4 (FIGS. 5 and 6) from the substrate 1.

As shown in FIGS. 5 and 6, the filter 4 cut off from the substrate 1, which is a flat plate, has a first major surface 41 and a second major surface 42 opposite to the first major surface 41. The first major surface 41 is formed by the upper surface of the substrate 1 and the second major surface 42 is formed by the lower surface of the substrate 1. Hence, the first major surface 41 is generally parallel to the second major surface 42 and the distance between the first and second major surfaces 41, 42, which will be referred to as first distance, equals to the thickness of the substrate 1.

In this embodiment, the slot 2 is made in the first major surface 41 of the filter 4, which corresponds to the upper surface of the substrate 1. The slot 2 has a bottom 43, which will be hereinafter referred to as first adhibit face, is generally parallel to the first major surface 41 of the filter 4, although it is not necessary to be so, and at the same time surrounding the first major surface 41 (as shown in FIG. 6). In other words, the first adhibit face 43 is formed by removing a portion of material from the upper surface of the substrate 1. Apparently, the distance between the first adhibit face 43 and the second major surface 42 of the filter 4, which will be referred to as second distance, is less than the first distance between the first major surface 41 and the second major surface 42.

Cutting of the slot 2 is performed with a cutter having a given thickness that is employed to cut into the upper surface of the substrate 1 in a direction substantially perpendicular to the upper surface (namely the first major surface 41 of the filter 4) and forming a plurality of slim slots closely arranged side by side with edges of the slim slots coincident with and connected to each other. Hence, a surrounding surface 44, which will be hereinafter referred to as first surrounding surface, is thus formed between the bottom surface 43 (namely the first adhibit face) of the slot 2 and the first major surface 41, which is approximately perpendicular to both the first adhibit face 43 and the first major surface 41. Similarly, when the cutter is made to cut completely through the substrate 1 to the lower surface (namely the second major surface 42) of the substrate 1, another surrounding surface 45, which will be hereinafter referred to as second surrounding surface, is formed between the first adhibit face 43 and the second major surface 42. Thus, the second surrounding surface 45 is formed due to the cutting operation of the cutter after the first adhibit face 43 is formed.

As the feeding direction of the cutter is substantially perpendicular to the upper surface (namely the first major surface 41) or the bottom surface thereof (namely the second major surface 42) of the substrate 1, the first surrounding surface 44 and the second surrounding surface 45, which are formed due to the feeding process of the cutter, are substantially parallel to each other on either sides of the filter 4. Moreover, the perpendicular distance between the first and second surrounding surfaces 44, 45 is, theoretically, half of difference between the width of the slot 2 and the thickness of the cutter (the black portion shown in FIG. 4).

As previously mentioned, the width of the slot 2 is at least double the thickness of the cutter. Therefore, the distance between the first and second surrounding surfaces 44, 45 is at least half of the thickness of the cutter. However, according to another embodiment of the present invention, the distance between the first and second surrounding surfaces 44, 45 is equal to or more than the thickness of the cutter. It is understood that the distance between the first and second surrounding surfaces 44, 45 is selected to avoid potential corner breaking problems caused when the cutter is made to cut through the substrate 1. Hence, as long as the cutter does not contact the first major surface 41, the distance between the first and second surrounding surfaces 45 does not need to be limited to any specific size.

Since in the third step, when cutting through the plate 1, the cutter does not directly contact the coated surface (namely the first major surface 41 in this embodiment) whereby the coating layers will not be damaged. This effectively improves the situation caused by corner breaking of the filter 4. However, the cutter will still contact the first adhibit face 43 during the cutting process of the third step, it is also possible that corner breaking occurs at the area of the first adhibit face 43 adjoining to the second surrounding surface 45, just as shown by the dashed lines of FIG. 5. This does not adversely affect the advantages of the present invention because there is no coating layer on the first adhibit face 43.

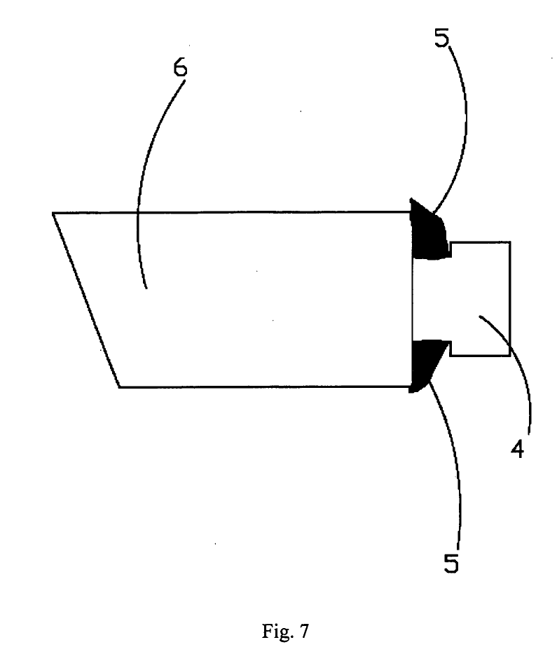

Referring to FIG. 7, in an assembly process, glue or adhesive 5 is applied to a whole end face of a Grin lens 6 to which the filter 4 is to attach. The glue 5 fills in a space between the first adhibit face 43 and the first surrounding surface 44 of the filter 3, and is for example cured by heating. As there is no broken corner on the surface of the filter 4 (namely the first major surface 41) facing the end face of the Grin lens 6, the filter 4 can then be closely adhered onto the Grin lens 6. This helps to prevent the glue 5 from causing the filter 4 to partly leave or tilt from the Grin lens 6 due to thermal expansion thereof, which may lead to such problems as changes of optical routes and optical characteristics thereof.

The present invention adopts a two-phase cutting process to avoid the previously mentioned corner breaking caused by direct contact between a cutter and the coating layers of the plate 1 when the cutter is made to start cutting or is made to leave after finishing the cutting due to the inner stress factors of the coating layers thereof.

It is to be understood, however, that even though numerous characteristics and advantages of the present invention have been set forth in the foregoing description, together with details of the structure and function of the invention, the disclosure is illustrative only, and changes may be made in detail, especially in matters of material, plating method and manufacturing process within the principles of the invention to the full extent indicated by the broad general meaning of the terms in which the appended claims are expressed.

What is claimed is:

1. A cutting method for a DWDM filter, comprising:
(1) forming a slot in a substrate according to size requirement of a finished product of the DWDM filter with a cutter having a given thickness, the slot having a width larger than the thickness of the cutter;
(2) forming coating on the substrate; and
(3) cutting completely through the substrate at a center point of the slot to separate the filter off the substrate.

2. The cutting method as claimed in claim 1, wherein in step (2), a plurality of coating layers with high and low refractivity are alternately formed on at least one surface of the substrate.

3. The cutting method as claimed in claim 1, wherein the width of the slot is at least double the thickness of the cutter.

4. The cutting method as claimed in claim 2, wherein the cutter does not directly contact the coating layers of the substrate in performing cutting of step (3).

5. The cutting method as claimed in claim 1, wherein a monitoring area for coating process is set on the substrate and wherein the slot is formed outside the monitoring area.

6. The cutting method as claimed in claim 5, wherein the slot is formed by repeated cutting.

7. A DWDM optical filter, comprising:
a first major surface;
a second major surface parallel to the first major surface and having a first distance from the first major surface;
a first adhibit face formed by recessing the first major surface toward the second major surface, whereby the first adhibit face surrounds the first major surface and has a second distance from the second major surface;
a first surrounding surface connecting the first adhibit face and the first major surface; and
a second surrounding surface connecting the first adhibit face and the second major surface;
wherein a specific distance is formed between the first and second surrounding surfaces, and the first adhibit face is formed by making a cutter having a given thickness cut from the first major surface to the first adhibit face for several times.

8. The DWDM optical filter as claimed in claim 7, wherein the distance between the first and second surrounding surface is no less than the thickness of the cutter.

9. The DWDM optical filter as claimed in claim 7, wherein the second surrounding surface is formed by cutting with a cutter having a desired thickness after the first adhibit face is formed.
